(19) United States
(12) Patent Application Publication
(10) Pub. No.: US 2020/0204461 A1
(43) Pub. Date: Jun. 25, 2020

(54) AUTOMATION SYSTEM FOR TESTING AND PUBLISHING OF WEB SERVICE

(71) Applicant: GEMINI OPEN CLOUD COMPUTING INC., Hsinchu City (TW)

(72) Inventor: Cheng-Yi Fang, HSINCHU CITY (TW)

(21) Appl. No.: 16/227,518

(22) Filed: Dec. 20, 2018

(51) Int. Cl. H04L 12/24

(52) U.S. Cl. CPC H04L 41/5054; H04L 41/5038

(57) ABSTRACT

An automation system for testing and publishing of web service uses a management interface to manage the test according to the version of API description document of the web service. The web service that has passed the testing will automatically finish the service registration, or provide the testing result to the management interface for the manager or the developer to revise the registry information. Therefore, through the API description document, the web service provider can test the web service, update the service or halt the service without any effect on the published web service, and provide error message for the web service provider to debug the registry information.

### BACKGROUND

### Field

The present application relates to a management system of web service, and especially to the automated management system for testing and publishing of web service.

### Description of Certain Related Art

In general, a firewall is configured to avoid the local network exposing under the internet, and the web-service cloud is set in a demilitarized zone (DMZ), which is a controlled and protected network area between internet and local network area. An application program interface (API) gateway is configured to control the access to web services, and then to reduce the coupling between the client end and the server end. The provider of the web services builds, publishes, maintains and monitors the web services through the API gateway. Thus the network security is enhanced by the API gateway.

However, it is a big burden to publish or update a web service. A web service needs to pass the unit test, integrated test, and system test before publishing. If an error occurs after publishing, the web-service system has to restore the system environment of a previous version, and that must be a disaster to the web-service provider.

The present application proposes a solution to automate the management system of testing and publishing web services, to reduce the burden of the provider and to enhance the management efficiency.

### SUMMARY OF THE INVENTION

The present application proposes an automation system to avoid interrupting the web services in the updating process due to testing and publishing of the web services.

The present application proposes an automation system to automatize the procedures of testing and publishing web services in the environment of the online system, so that the provider does not need to prepare an additional testing environment, thereby minimizing the fail risk caused by environment compatibility.

The present application proposes an automation system to manage the version of web service, which is convenient for the provider to expand or to extend the web services.

An automation system for testing and publishing web services comprises a management dashboard, a message queue, a multiprocessing module, an API description document interpreter, an API gateway and a service registry module. The management dashboard receives an API description document, parses the API description document, puts a testing message in the message queue, and tests the list of web services from the API gateway. The API description document comprises the registry information of the web service. The message queue receives the message, transforms the message to a testing instruction and queues the testing request. The multiprocessing module takes the testing request and transmits the API description document to the API description document interpreter. Then the API description document interpreter sends a request to one web service of the web-service cloud system according to the API description document, and the web service receives the request in response to the API description document interpreter and transfers the result to the multiprocessing module. The multiprocessing module integrates the testing result to generate a report and transmits the report to the API gateway. The API gateway publishes a successful web service testing result and registers the web service on the web-service system. If the test does not pass, the API gateway reports a failed web service to the management dashboard.

An automation method for testing and publishing the web services comprises the following steps. The first step is to deploy a web service on the web-service system. The second step is to upload an API description document via a management dashboard, where the API description document comprises a registration information. The third step is to transform a testing message into a testing instruction format and to write the instruction onto a message queue by using the management dashboard. The fourth step is to read the testing instruction out of the message queue and to transmit the API description document to an API description document interpreter through the multiprocessing module. The fifth step is to execute the testing program of the web service according to the API description document by using the API description document interpreter. The interpreter sends a request to the web-service system, receives and collects the responses from the web-service system, and then passes the results to the multiprocessing module. The sixth step is to generate a testing report and sends the report to the API gateway. The API gateway registers the service on the web-service system for the web service that passed the test and to publish the web service automatically, or reports the testing result to management dashboard for the failed web service.

### BRIEF DESCRIPTION OF THE DRAWINGS

The drawings employed here are used to explain and not to limit the present application. The drawings do not mean the whole features of the present application, but some element(s) or some strep(s) is essential for the features of the present application. In some configuration, some element(s) or step(s) can be modified to reach some function according to the spirit of the present application, and that should be in the scope of the present application, i.e. more precisely, the scope of the present application is defined in the claims.

FIG. 1 shows schematically an architecture of an automation system for testing and publishing.

FIG. 2 shows schematically a flowchart that illustrates interactions between elements of the automation system for testing and publishing as shown in FIG. 1.

### DETAILED DESCRIPTION OF CERTAIN EMBODIMENTS

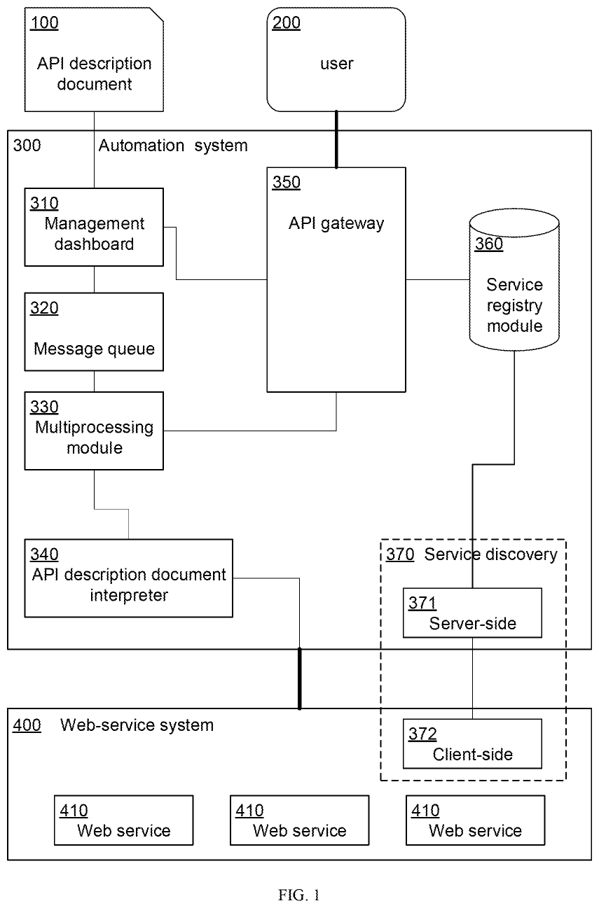

Referring to the FIG. 1, an automation system 300 for testing and publishing web service according to an embodiment of the present application is illustrated. In the automation system 300, an API gateway 350 has been integrated, and the system is deployed in a DMZ (demilitarized zone). The automation system 300 reads an API description document and starts to test, to report, to register and to publish web services. The automation system 300 for testing and publishing web services proposed by the present application uses a management dashboard 310, a message queue 320, a multiprocessing module 330, an API description document interpreter 340, an API gateway 350 and a service registry module 360 to automate the management of testing and publishing the web services.

The automation system 300 uploads the API description document 100 by using the management dashboard 310, interacts with the web-service system 400 to test a web service, and the API gateway 350 registers the web service. Then the web service starts to provide the service to a client end 200. The automation system automates the procedure of testing and publishing one web service according to the API description document 100.

Moreover, the automation system 300, according to the embodiment of the present application shown in FIG. 1, for testing and publishing web services can accompany with a service discovery module 370, which is able to discover automatically the services deployed in web-service system, to test the web services and to complete the registration of the web services. The service discovery module 370 comprises a server-side component 371 and a client-side component 372. The client-side component 372 is deployed in the web-service system 400 and the server end in the automation system 300. Any web service 410 that starts to run will trigger the client-side component 372 to communicate with the server-side component 371 to check the registry status of the web service. The procedure of testing the web service starts to run if the web service is not registered, and completes the registration if the web service passed the testing and starts to provide the web service. The automation system 300 integrated with the service discovery module 370 is able to discover, test and register automatically the web service. It is empathically noted that the web-service system may be called a cloud also, and it could be a single web-service system or it could include distributed web-service systems.

First, the API description document includes the information including the web-service name, version, the IP address of the host, the path of the web service, the content of the web service, and the parameters of the web service and its type, the testing instructions of the web service, the testing item of the web service, the location of the testing report and so on. The API description document is configured to be extendable and expandable. In practice, the API description document 100 could be edited in the JSON or YAML format, which is a kind of serialized data type to have higher flexibility and readability than the traditional instruction file.

Second, the management dashboard comprises the functions at least below:
(1) It provides a user interface to edit the API description document 100 and to validate the format of the API description document 100. The API description document 100 is edited strictly in grammar, and the user could edit or revise the API description document 100 in the management dashboard 310, which checks the grammar of the API description document automatically.
(2) It provides an interface to manage a testing task. The web service provider could trigger a testing procedure, by writing a test message into the message queue 320 through the management dashboard 310.
(3) It provides an interface to manage a testing task. The management dashboard provides great management function to let the user or manager be able to receive the testing report or lookup the testing reports from the API gateway, where information of the testing report includes the version, the testing result and the testing performance and so on. Therefore, the user or the manager could revise or improve the web service to improve the quality of the web service.
(4) It provides an interface with many functions, such as to receive the status of published web services (API), to lookup the registration status of the web services, to update or to unload the published web service. The web service provider could get the current status or information of the web services. The web service could start to work once it passed the testing or it will not disrupt the current version of the web service.

Third, the multiprocessing module 330 controls the testing procedure by reading the testing message and loading the API description document. Then the multiprocessing module 330 drives the API description document interpreter 340 to start to test the web service according to the API description document and receives the testing results to determine whether the web service passed the test or not according to the API description document 100. For the web services that failed the testing, the multiprocessing module 330 transmits the testing report to the management dashboard 310, and the web service provider can revise the API description document 100 based on the testing result. For the web services that passed the testing, the multiprocessing module 330 drives the API gateway 350 to register the web service and to publish the web service according to the API description document 100.

Forth, the API gateway 350 interacts with the multiprocessing module 330 to be the gateway of the web services. The API description document 100 comprises the information of web-service name, host, path and content and so on. The API gateway 350 registers the web service on service registry module 360 and then publishes the web service.

Fifth, the message queue 320 receives the testing message from the management dashboard 310 and buffers the testing message. Later, the multiprocessing module 330 reads the testing message to proceed with the testing.

Sixth, the API description document interpreter 340 is used to receive the instruction from the multiprocessing 330 to test the web service according to the API description document 100. The API description document interpreter 340 sends a request to the web service 410 deployed on the web-service system 400 and to receive the response from the web service 410. The instructions of the testing include “build”, “delete”, “update” and “get”, and the type of instruction is extendable and expandable. The instructions are transformed into the HTTP or RESTful format, so the testing instructions can be transmitted via HTTP protocol. The API description document interpreter 340 interacts with the web service 410 in the web-service system 400. The API description document interpreter 340 sends a request to the web service 410 according to the API description document 100, the web service 410 computes to get a result and responds to the API description document interpreter 340. Then the API description document interpreter 340 returns the response to the multiprocessing module 330.

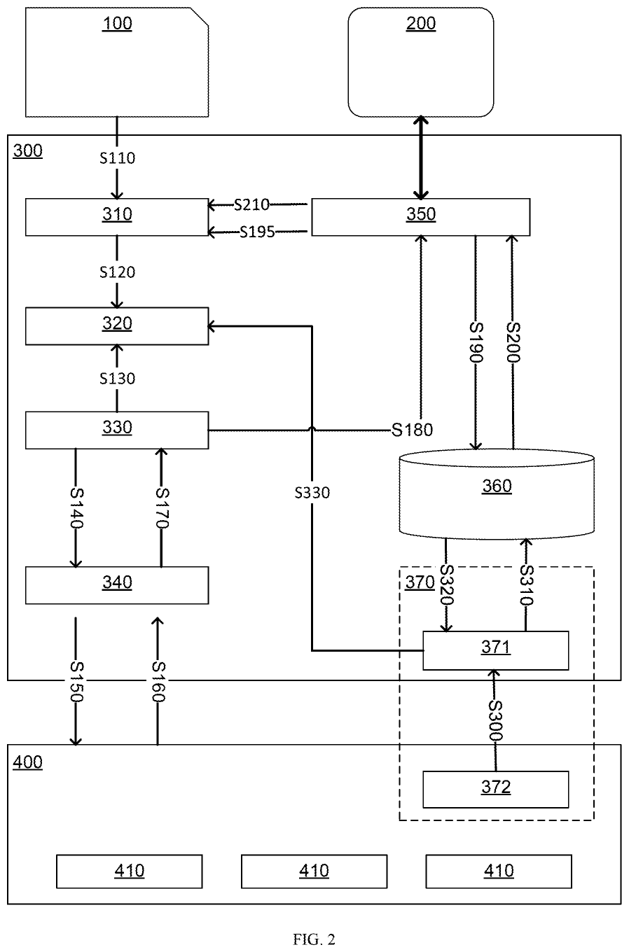

FIG. 2 shows the interactions between components during the automated process for testing and publishing the web service.
Step S100 (not shown in FIG. 2) is to deploy the web service in the web-service system.
Step S110 is to load the API description document onto the automation system for testing and publishing the web service through the management dashboard.
Step S120 is to push a testing message into a message queue 320 to request a testing once the management dashboard 310 receives the API description document 100.
Step S130 is to read out the testing instruction from the queue 320 through the multiprocessing module 330.
Step S140 is to run the testing task. The multiprocessing module 330 transmits the API description document 10 to the API description document interpreter 340.
Step S150 is to send a request to one web service 410 in the web-service system 400 according to the API description document through the API description document interpreter 340.
Step S160 is to receive the response from the web service 410 through the API description document interpreter 340.
Step S170 is to return the testing result to the multiprocessing module 340 through the API description document interpreter 340 and then to generate a testing report.
Step S180 is to send the testing report to the API gateway 350 through the multiprocessing module 330 to register the web service if succeeded.
Step S190 is to drive the service registry module 360 to register the web service through the API gateway 350.
Step S195 is to report to the management dashboard 310 through the multiprocessing module 330 if failed, and the user or the manager could revise or improve the API description document 100 according to the report.

The automation system for testing and publishing the web service can be equipped with a service discovery module to have the function of Service Discovery, and the automation system is able to discover automatically the web service, to test the web service and to publish the web service. The service discovery module comprises a server-side component and a client-side component, and the service-side component interacts with the service registry module to automatize the service discovery. The service registry module comprises a database to maintain the web services and the path to the service location, i.e. host of the service. The server-side component of the service discovery module is located at the automation system for testing and publishing the web service. The client-side component of the service registry module is located at the web-service system. The service discovery module could look up the database of the service registry module. The client-side component could send a request of registering the web service to the server-side component. Once a web service starts, the client-side component sends the registering request with the information to the server-side component, where the request information comprises the service name, host name, IP address, status page, health check and so on. The server-side component looks up the registration status of the web service, and pushes a testing message into the message queue to trigger a testing if the web service is not found, i.e. not registered. The multiprocessing module reads out the testing message to complete the testing and registration, as mentioned above in this document. Once a web service stops, the service registry is also triggered the server-side component to look up the registration status and to remove the registry information. If the automation system is not equipped with the service discovery module, the user or the manager is able to test, to register or to remove web service via the management dashboard.

The process of service discovery is explained below:
Step S100 (not shown in FIG. 2) is to deploy a web service in the web-service system.
Step S300 is to request registration. Once the web service 410 starts, the client-side component 372 sends a message with an API description document 100 to the server-side component 371 of the service discovery module 370 to request the registration status.
Step S310 is to look up the registration status. The server-side component 372 of the service discovery 370 reads the registration status from the database of the service registry module 360.
Step S320 is to return the registration status. The service registry module 360 returns the registration status to the server-side component 371 of the service discovery module 370.
Step S330 is to request a testing. The server-side component 371 of the service discovery module 370 writes a testing message with the API description document into the message queue 320.
Step S140-S195 are the steps to complete the testing and registering as mentioned above.

The user or manager can also use the management dashboard 310 to look up the registration status of a service through the API gateway to complete the testing and registering manually. The process is as below:
S200 is to look up the registration status. The API gateway 350 drives the service registry module to get a service list.
Step S210 is to receive the service list. The API gateway 350 returns the service list to the management dashboard 310, and the user or manager is able to upload the API description document 100 to test, to register and to publish a web service manually if the web service is not registered in the service list.
Step S140-S195 are the steps to complete the testing and registering as mentioned above.

It is noted that the automation system for testing and publishing the web service with different versions, so the testing and publishing does not affect the published web service. The user uses the version of the API description document 100 to handle the updating to the web service. The web services with different versions do not affect each other and the published service.

What is claimed:

1. An automation system for testing and publishing a web service, comprising:
a management dashboard, a message queue, a multiprocessing module, an API description document interpreter, an API gateway and a service registry module, wherein
the management dashboard is configured to receive an API description document, to parse the API description document, to write a testing message into the message queue, to receive a service list from the API gateway and to be as an operation interface, wherein the API description document is related to a registry information of a web service;
the message queue is configured to receive the testing message, to transform the testing message into a testing instruction and to queue the testing instruction;
the multiprocessing module is configured to read the testing instruction from the message queue and to transmit the API description document to the API description document interpreter;
the API description document interpreter is configured to send a request to the web service located in a web-service system, to receive a response with a result related to the request from the web service and to transfer the result to the multiprocessing module;
the multiprocessing module is configured to receive the results to make a testing report, which is used by the API gateway to determine to publish the web service or not; and
the API gateway is configured to register the web service in the service registry module and to publish the web service if passed, or to report the testing report to the management dashboard if failed.

2. The automation system for testing and publishing the web service according to claim 1, further comprising a service discovery module, wherein the service discovery module comprises a server-side component located at the automation system and a client-side component located at the web-service system, and the client-side component sends a request with the registry information to the server-side component to look up the registration status of the web service once the web service starts, and then to write a testing message into the message queue if the web service is not registered.

3. The automation system for testing and publishing the web service according to claim 1, wherein the API description document comprises the registration information of the web service.

4. The automation system for testing and publishing the web service according to claim 3, wherein the API description document are edited in a JSON or YAML format.

5. A method for testing and publishing a web service, comprising:
deploying a web service in a web-service system;
uploading an API description document through a management dashboard, wherein the API description document is related to the web service;
writing a testing message into a message queue through the management dashboard;
transforming the testing message into a testing instruction and queueing the testing instruction in the message queue;
reading the testing instruction and the API description document through a multiprocessing module, and driving an API description document interpreter to request a testing for the web service;
sending requests to the web service in the web-service system through the API description document interpreter, receiving the response with results from the web-service system and returning the results to the multiprocessing module; and
registering and publishing the web service on a service registry module through an API gateway driven by the multiprocessing module when the testing is succeeded, or
reporting testing results to the management dashboard through the multiprocessing module when the testing is failed.

6. The method for testing and publishing the web service according to claim 5, further comprising a step of discovering the web service through a service registry module, wherein the service registry module is configured to discover a web service, to check registry status of the web service and to test and register the web service if the web service is not registered by writing a testing message into a message queue and to trigger a testing and registration procedure.

7. The method for testing and publishing the web service according to claim 6, wherein the service registry module comprises a server-side component and a client-side component, the server-side component is located in an automation system for testing and publishing the web service, the client-side component is located at a web-service system, the client-side component sends a request with an API description document to the service-side component to look up the registration status of the web service, and the service discovery module writes the testing message to the message queue to start a testing procedure.
